(19) United States
(12) Patent Application Publication
(10) Pub. No.: US 2006/0182445 A1
(43) Pub. Date: Aug. 17, 2006

(54) Wavelength division multiplexed passive optical network system using light source wavelength-locked by injected incoherent light

(75) Inventors: Jae-Hoon Lee, Seoul (KR); Kwan-Soo Lee, Seoul (KR); Chang-Sup Shim, Seoul (KR); Gyu-Woong Lee, Suwon-si (KR); Seong-Taek Hwang, Pyeongtaek-si (KR)

Correspondence Address: CHA & REITER, LLC, 210 ROUTE 4 EAST STE 103, PARAMUS, NJ, 07652, US

(73) Assignee: Samsung Electronics Co.; LTD

(21) Appl. No.: 11/355,408

(22) Filed: Feb. 16, 2006

(30) Foreign Application Priority Data
Feb. 16, 2005 (KR) 12810/2005

(51) Int. Cl. H04J 14/00

(52) U.S. Cl. 398/72

(57) ABSTRACT

Disclosed is a wavelength-division-multiplexed passive optical network (WDM-PON) using a light source wavelength-locked by an injected incoherent light. The WDM-PON system includes: an injection light generating section, which includes a broadband light source emitting an incoherent optical signal, so as to provide a route for an uplink signal and a route for a downlink signal according to time; a central office for receiving the incoherent optical signal generated by the injection light generating section, transmitting a downlink light by wavelength-locking the received incoherent optical signal, receiving an uplink optical signal from a subscriber unit, and detecting a light from the received uplink optical signal; and the subscriber unit for receiving the incoherent optical signal generated by the injection light generating section, transmitting an uplink light by wavelength-locking the received incoherent optical signal, receiving a downlink optical signal from a central office, and detecting a light from the received downlink optical signal.

### CLAIM OF PRIORITY

This application claims priority under 35 U.S.C. 119(a) to an application entitled “Wavelength Division Multiplexed Passive Optical Network System Using Light Source Wavelength-Locked By Injected Incoherent Light,” filed in the Korean Intellectual Property Office on Feb. 16, 2005 and assigned Serial No. 2005-12810, the contents of which are incorporated herein by reference.

### BACKGROUND OF THE INVENTION

1. Field of the Invention

The present invention relates to a wavelength-division-multiplexed passive optical network (WDM-PON), and more particularly to a wavelength-division-multiplexed passive optical network using a light source wavelength-locked by an injected incoherent light.

2. Description of the Related Art

Wavelength-division-multiplexed passive optical networks (WDM-PONs) provide ultra high-speed broadband communication service by allocating specific wavelengths to each subscriber unit. By allocating specific wavelengths to each subscriber unit, WDM-PONs increase communication capacity for each subscriber unit, ensure communication security, and accommodate new subscriber units, thereby easily enlarging the WDM-PON system.

When such a WDM-PON uses a light source wavelength-locked by an injected incoherent light, the wavelength of an optical transmitter is determined based on the wavelength of the injected incoherent light. Such a WDM-PON has an advantage in that the dependency on the wavelength of the optical transmitter can be removed. In addition, since the WDM-PON can provide the wavelengths for a plurality of optical transmitters by using a broadband light source, it is unnecessary to include separate light sources for each wavelength. Therefore, such a WDM-PON system can be constructed at a low cost.

A WDM-PON using a light source wavelength-locked by an injected incoherent light is disclosed in Korean Patent Application No. 10-2002-0060868, entitled “Bidirectional Wavelength Division Multiplexed Passive Optical Network Using Light Source Wavelength-Locked By Injected Incoherent Light” and filed by Novera Optics Korea, Inc.

FIG. 1 is a block diagram illustrating the construction of a conventional WDM-PON using a light source wavelength-locked by an injected incoherent light.

The conventional WDM-PON using a light source wavelength-locked by an injected incoherent light includes B-band optical transmitters 101 to 103, A-band optical transmitters 130 to 132, optical receivers 104 to 106, and 127 to 129, an A-band amplified spontaneous emission (ASE) light source 113, a B-band ASE light source 114, 2×2 optical couplers 115 and 116, wavelength division multiplexers 107 to 109, 117, 118, and 124 to 126, optical terminators 119 and 120, 1×n optical multiplexing/demultiplexing units 112 and 123, an adder 110, a temperature control unit 111, and an optical fiber failure detection unit 121.

Herein, wavelength division multiplexers 107 to 109, 117, 118, and 124 to 126 output an input light having a wavelength of the B-band to a node being in parallel to a relevant input node, and output an input light having a wavelength of the A-band to a node being in perpendicular to a relevant input node.

The optical multiplexing/demultiplexing units 112 and 123 may be constructed with an arrayed waveguide grating (AWG), and can operate in two or more wavelength bands. The characteristics of the arrayed waveguide grating are described in detail in a paper entitled “Transmission Characteristics of Arrayed-waveguide N×N Wavelength multiplexer”, IEEE Photonic Technology Letters, vol. 13, pp. 447-445.

According to the prior art as illustrated in FIG. 1, in order to create a wavelength-locked light source using an incoherent light, an uplink-band (A-band) ASE light source and a downlink-band (B-band) ASE light source are connected through a 2×2 optical coupler. Referring to FIG. 1, since a wavelength-locked light source for an uplink signal is created using the A band, and wavelength-locked light source for a downlink signal is created using the B band, the wavelength division multiplexers 107 to 109, 117, 118, and 124 to 126 are required in order to distinguish the uplink/downlink optical signals from each other, and uplink-band and downlink-band ASE light sources are separately required. In addition, the uplink optical transmitters must be constructed with A-band optical transmitters, while the downlink optical transmitter must be constructed with B-band optical transmitters.

FIG. 2 is a view illustrating uplink and downlink optical signals used in the prior art. In the prior art, as shown in FIG. 2, in order for uplink and downlink light sources to be wavelength-locked in different wavelengths, an optical signal is divided into an uplink signal band 21 and a downlink signal band 22, and the divided optical signal are used as injection lights for wavelength-locked light sources.

As described above, in the prior art a WDM-PON using light sources wavelength-locked by injected incoherent lights, utilizing optical signals of different bands as injection lights for the uplink and downlink light sources. In addition, the prior art requires that ASE light sources have different bands and wavelength division multiplexers are required in order to distinguish uplink and downlink signals from each other. Therefore, since one channel occupies two wavelength bands, optical signals delivered through uplink and downlink channels are transmitted at the same speed.

In the case of Internet data used in a general subscriber network, downlink data is much more larger than uplink data, requiring an unnecessarily large band occupied by the uplink data in the conventional bidirectional WDM-PON using two wavelength bands, thereby degrading its efficiency. Also, since the lights of the uplink and downlink optical transmitters must be wavelength-locked by incoherent lights of different wavelengths, an optical transmitter and optical receiver having different characteristics are required.

### SUMMARY OF THE INVENTION

Accordingly, the present invention has been made to solve the above-mentioned problems occurring in the prior art, and one aspect of the present invention is to provide a wavelength-division-multiplexed passive optical network (WDM-PON) using a light source wavelength-locked by an injected incoherent light, which employs a time division duplex (TDD) scheme, in which injection lights of the same wavelength are allocated for uplink and downlink, thereby improving the efficiency of the WDM-PON, reducing the type of required incoherent lights into one, and enabling the same optical transmitters and receivers to be used for the uplink and downlink, so as to reduce the fabrication cost of the optical transmitter and receiver.

Another aspect of the present invention is to provide a WDM-PON, in which an uplink signal transmission range and a downlink signal transmission range are separated from each other, so that the range for the transmission of the uplink signal is less than the downlink signal and can be adaptively re-constructed, thereby improving the efficiency of the WDM-PON.

To accomplish these objectives, in accordance with one embodiment of the present invention, there is provided a wavelength-division-multiplexed passive optical network (WDM-PON) system using a light source wavelength-locked by an injected incoherent light. The WDM-PON system comprises: an injection light generating section, which includes a broadband light source emitting an incoherent optical signal, so as to provide a route for an uplink signal and a route for a downlink signal according to time. A central office is also provided for receiving the incoherent optical signal generated by the injection light generating section, transmitting a downlink light by wavelength-locking the received incoherent optical signal, receiving an uplink optical signal from a subscriber unit, and detecting a light from the received uplink optical signal. The WDM-PON system further comprises a subscriber unit for receiving the incoherent optical signal generated by the injection light generating section, transmitting an uplink light by wavelength-locking the received incoherent optical signal, receiving a downlink optical signal from a central office, and detecting a light from the received downlink optical signal. Finally the uplink and downlink optical signals transmitted between the injection light generating section, the central office, and the subscriber unit are controlled according to time.

### BRIEF DESCRIPTION OF THE DRAWINGS

The above features and advantages of the present invention will be more apparent from the following detailed description taken in conjunction with the accompanying drawings, in which:

FIG. 1 is a block diagram illustrating the construction of a conventional WDM-PON using a light source wavelength-locked by an injected incoherent light;

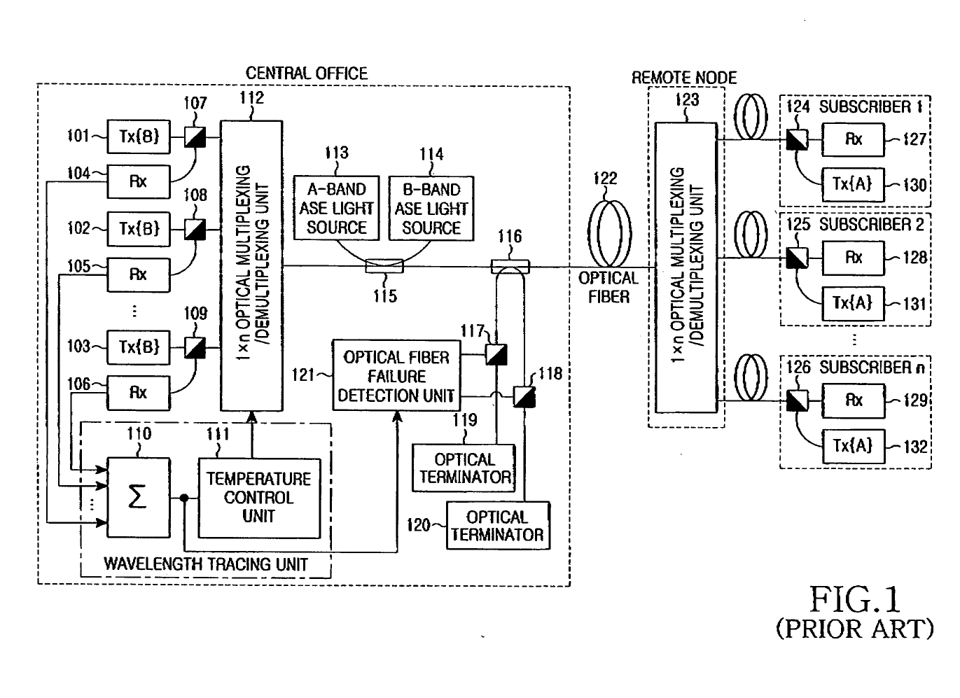

FIG. 2 is a view illustrating uplink and downlink optical signals used in the prior art;

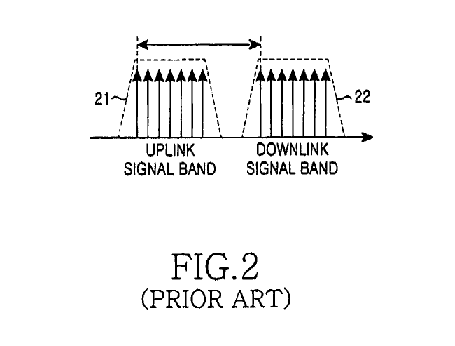

FIG. 3 is a block diagram illustrating the construction of a WDM-PON using a light source wavelength-locked by an injected incoherent light according to a first embodiment of the present invention;

FIG. 4 is a view illustrating a result of detection for each position of uplink and downlink data in the system having the construction shown in FIG. 3;

FIG. 5 is a block diagram illustrating the construction of a WDM-PON using a light source wavelength-locked by an injected incoherent light according to a second embodiment of the present invention; and

FIG. 6 is a view illustrating a result of detection for each position of uplink and downlink data in the system having the construction shown in FIG. 5.

### DETAILED DESCRIPTION

Hereinafter, preferred embodiments of the present invention will be described with reference to the accompanying drawings. For the purposes of clarity and simplicity, a detailed description of known functions and configurations incorporated herein will be omitted as it may make the subject matter of the present invention unclear.

According to the present invention a bidirectional wavelength-division-multiplexed passive optical network (WDM-PON) utilizing a light source wavelength-locked by an injected incoherent light is disclosed wherein, uplink and downlink light sources are wavelength-locked by incoherent lights having the same wavelength. The uplink and downlink light sources have the same wavelength because they are wavelength-locked in the same wavelength. In order to prevent the uplink and downlink signals, which have the same wavelength, from colliding with each other, the present invention employs the time division duplex (TDD) scheme.

Hereinafter, the construction and operation of the WDM-PON according to the present invention will described with preferred embodiment of the present invention.

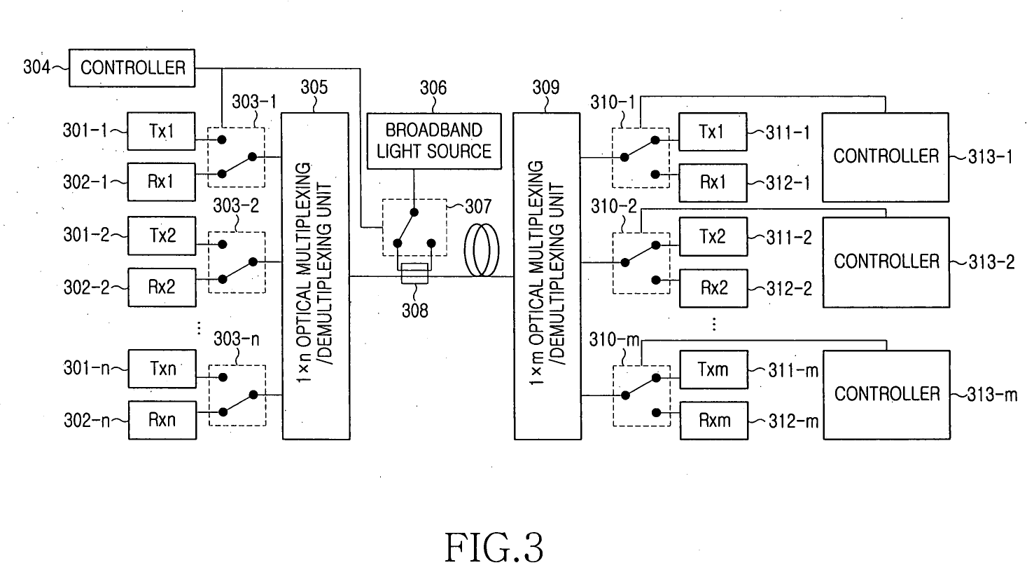

FIG. 3 is a block diagram illustrating the construction of a WDM-PON using a light source wavelength-locked by an injected incoherent light according to a first embodiment of the present invention.

Referring to FIG. 3, the WDM-PON includes an injection light generating section, which contains a broadband light source 306, an optical switch 307, and an optical router 308.

The injection light generating section in the first embodiment operates as follows. The broadband light source 306 emits an incoherent light. The optical switch 307 switches the incoherent light, which has been output from the broadband light source 306, either to optical transmitters 301-1 to 301-n of a central office or to optical transmitters 311-1 to 311-m of subscriber units, under the control of a controller 304 according to time. The optical router 308 establishes an optical route among the optical switch 307, the central office, and the subscriber units.

As illustrated in FIG. 3, the central office includes a 1×n optical multiplexing/demultiplexing unit 305, switches 303-1 to 303-n, the optical transmitters 301-1 to 301-n of the central office, optical receivers 302-1 to 302-n of the central office, and the controller 304.

The central office in the first embodiment operates as follows. The 1×n optical multiplexing/demultiplexing unit 305 receives and demultiplexes an uplink signal, and multiplexes downlink signals. The switches 303-1 to 303-n perform the switching operation in order to establish routes between the 1×n optical multiplexing/demultiplexing unit 305 and the optical transmitters 301-1 to 301-n of the central office, or routes between the 1×n optical multiplexing/demultiplexing unit 305 and the optical receivers 302-1 to 302-n of the central office, under the control of the controller 304 according to time. The optical transmitters 301-1 to 301-n of the central office are wavelength-locked by an incoherent light, which has been demultiplexed by the 1×n optical multiplexing/demultiplexing unit 305, and transmit downlink data. The optical receivers 302-1 to 302-n of the central office detect an uplink optical signal demultiplexed by the 1×n optical multiplexing/demultiplexing unit 305. The controller 304 controls the switches 303-1 to 303-n and the optical switch 307 so that the switches 303-1 to 303-n, and 307 perform switching operations for either uplink or downlink according to time.

As illustrated in FIG. 3, each subscriber unit includes a 1×m optical multiplexing/demultiplexing unit 309, switches 310-1 to 310-m, the optical transmitters 311-1 to 311-m for each subscriber unit, optical receivers 312-1 to 312-m for each subscriber unit, and controllers 313-1 to 313-m for each subscriber unit.

The subscriber unit that operates in the first embodiment operates as follows. The 1×m optical multiplexing/demultiplexing unit 309 receives and multiplexes uplink signals, and demultiplexes a downlink signal. The switches 310-1 to 310-m perform the switching operation in order to establish routes between the 1×m optical multiplexing/demultiplexing unit 309 and the optical transmitters 311-1 to 311-m for each subscriber unit, or routes between the 1×m optical multiplexing/demultiplexing unit 309 and the optical receivers 312-1 to 312-m for each subscriber unit, under the control of the controller 340 according to time.

The optical transmitters 311-1 to 311-m for each subscriber unit are wavelength-locked by an incoherent light, which has been demultiplexed by the 1×m optical multiplexing/demultiplexing unit 309, and transmit uplink data. The optical receivers 312-1 to 312-m for each subscriber unit detect a downlink optical signal demultiplexed by the 1×m optical multiplexing/demultiplexing unit 309.

The controller 313-1 to 313-m for each subscriber unit control the switches 310-1 to 310-m so that the switches 310-1 to 310-m perform switching operations for either uplink or downlink according to time.

Hereinafter, the case for transmitting/receiving a downlink/uplink signal according to the present invention will be described with first embodiment of the present invention.

According to the construction as describe above, in the case of transmitting a downlink signal, when an incoherent optical signal is output from the broadband light source 306, the optical switch 307 performs the switching operation in order to establish a route to the 1×n optical multiplexing/demultiplexing unit 305 by the control of the controller 304. Incoherent optical signals separated by the 1×n optical multiplexing/demultiplexing unit 305 are transmitted to the optical transmitters 301-1 to 301-n of the central office through the switches 303-1 to 303-n under the control of the controller 304. Then, the incoherent optical signals are wavelength-locked in the optical transmitters 301-1 to 301-n of the central office, and are transmitted to the 1×n optical multiplexing/demultiplexing unit 305 through the switches 303-1 to 303-n under the control of the controller 304. The wavelength-locked optical signals of the optical transmitters 301-1 to 301-n are multiplexed by the 1×n optical multiplexing/demultiplexing unit 305, and then are output to the subscriber units.

A downlink optical signal multiplexed by the 1×n optical multiplexing/demultiplexing unit 305 is demultiplexed by the 1×m optical multiplexing/demultiplexing unit 309. The demultiplexed downlink optical signals are input to the switches 310-1 to 310-m, and are input to the optical receivers 312-1 to 312-m under the control of the controllers 313-1 to 313-m, so that optical detection is performed. Both the controller 304 of the central office and the controllers 313-1 to 313-m for each subscriber unit control the switching operations according to time.

In the case of an uplink signal according to the construction as describe above, when an incoherent optical signal is output from the broadband light source 306, the optical switch 307 performs the switching operation in order to establish a route to the 1×m optical multiplexing/demultiplexing unit 309 by the control of the controller 304. Incoherent optical signals demultiplexed by the 1×m optical multiplexing/demultiplexing unit 309 are transmitted to the optical transmitters 311-1 to 311-m for each subscriber unit through the switches 310-1 to 310-m under the control of the controllers 313-1 to 313-m. Then, the incoherent optical signals are wavelength-locked in the optical transmitters 311-1 to 311-m for each subscriber unit, and are transmitted to the 1×m optical multiplexing/demultiplexing unit 309 through the switches 310-1 to 310-m under the control of the controllers 313-1 to 313-m. The wavelength-locked optical signals of the optical transmitters 311-1 to 311-m are multiplexed by the 1×m optical multiplexing/demultiplexing unit 309, and then are output to the central office.

An uplink optical signal multiplexed by the 1×m optical multiplexing/demultiplexing unit 309 is demultiplexed by the 1×n optical multiplexing/demultiplexing unit 305. The demultiplexed uplink optical signals are input to the switches 303-1 to 303-n, and are input to the optical receivers 302-1 to 302-n of the central office under the control of the controller 304, so that optical detection is performed. Both the controller 304 of the central office and the controllers 313-1 to 313-m for each subscriber unit control the switching operations according to time.

As described above, since the switch performs the switching operation to establish a route for an uplink or a downlink according to time, uplink data or downlink data are transmitted according to time.

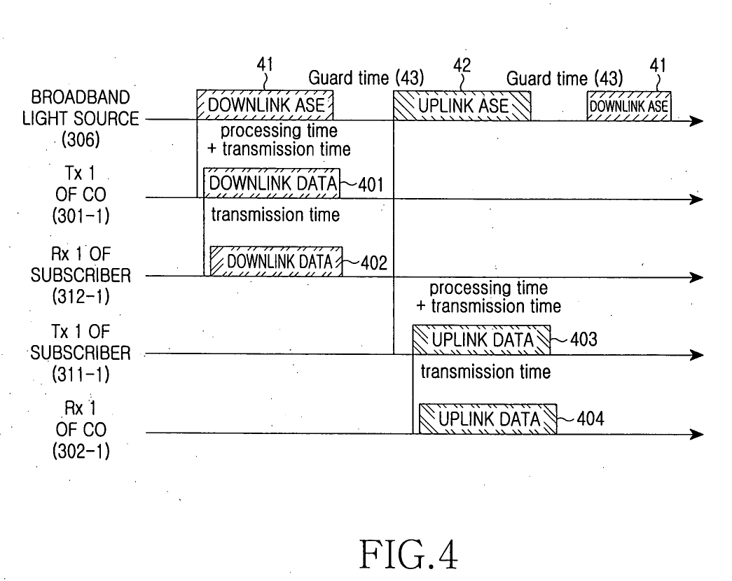

FIG. 4 is a view illustrating a result of detection for each position of uplink and downlink data in the system having the construction shown in FIG. 3.

As illustrated in FIG. 4, when the broadband light source 306 outputs a downlink incoherent optical signal (downlink ASE) 41 through the optical switch, the switches 303-1 to 303-n of the central office perform switching operations so that the incoherent optical signal is input to the optical transmitters 301-1 to 301-n and is wavelength-locked for downlink transmission. A downlink data 401 created by such a manner is transmitted to a subscriber unit through an optical fiber, and the switches 310-1 to 310-m of the subscriber units are switched so that the downlink data 401 may be transmitted to the optical receivers 312-1 to 312-m of the subscriber units and a downlink data 402 may be detected.

An operation similar to that described above is performed in the case of an uplink incoherent optical signal (See reference numerals 42, 403, and 404).

In order to prevent collisions between uplink and downlink signals, a guard time 43 is established upon the transmission of each broadband light source. Therefore, when a signal is transmitted to either the optical receivers or the optical transmitters for each unit, a difference in processing time and transmission time is caused according to its processing operation.

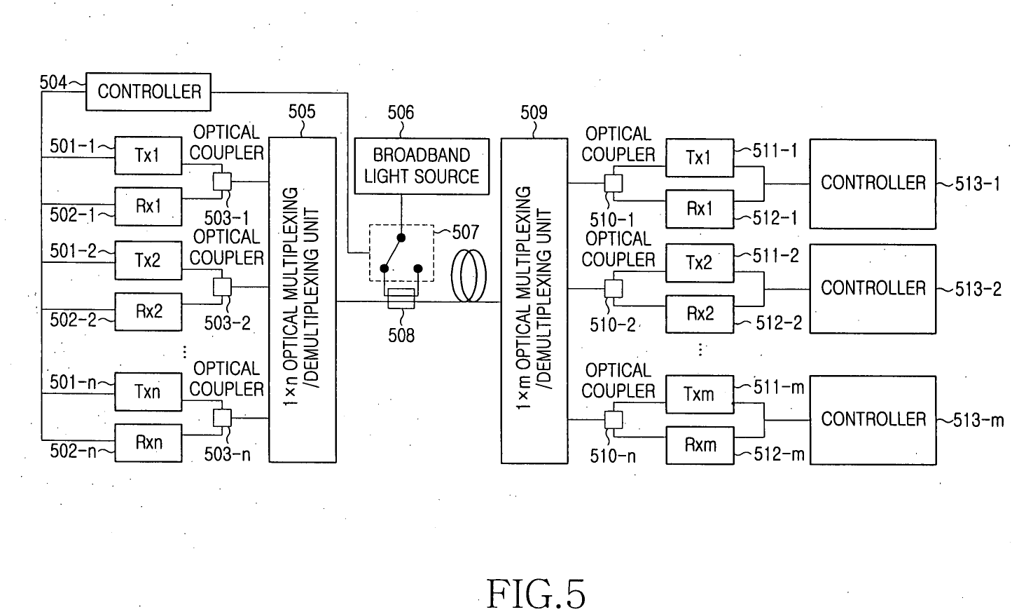

FIG. 5 is a block diagram illustrating the construction of a WDM-PON using a light source wavelength-locked by an injected incoherent light according to a second embodiment of the present invention.

Referring to FIG. 5, the WDM-PON according to the second embodiment of the present invention includes an injection light generating section, which contains a broadband light source 506, an optical switch 507, and an optical router 508.

The injection light generating section in the second embodiment operates as follows. The broadband light source 506 emits an incoherent light. The optical switch 507 switches the incoherent light, which has been output from the broadband light source 506, either to optical transmitters 501-1 to 501-n of a central office or to optical transmitters 511-1 to 511-m of subscriber units, under the control of a controller 504 according to time. The optical router 508 establishes an optical route among the optical switch, the central office, and the subscriber units.

As illustrated in FIG. 5, the central office includes a 1×n optical multiplexing/demultiplexing unit 505, optical couplers 503-1 to 503-n, the optical transmitters 501-1 to 501-n of the central office, optical receivers 502-1 to 502-n of the central office, and the controller 504.

The central office in the second embodiment operates as follows. The 1×n optical multiplexing/demultiplexing unit 505 receives and demultiplexes an uplink signal, and multiplexes downlink signals. The optical couplers 503-1 to 503-n transmit an output of the 1×n optical multiplexing/demultiplexing unit 505 to the optical transmitters 501-1 to 501-n of the central office and the optical receivers 502-1 to 502-n of the central office.

The optical transmitters 501-1 to 501-n of the central office are wavelength-locked by an incoherent light, which has been demultiplexed by the 1×n optical multiplexing/demultiplexing unit 505, and transmit downlink data. The optical receivers 502-1 to 502-n of the central office detect an uplink optical signal demultiplexed by the 1×n optical multiplexing/demultiplexing unit 505.

The controller 504 controls the optical switch 507 and controls the operations of the optical transmitters 501-1 to 501-n and optical receivers 502-1 to 502-n of the central office, according to time.

As illustrated in FIG. 5, each subscriber unit includes a 1×m optical multiplexing/demultiplexing unit 509, optical couplers 510-1 to 510-m, the optical transmitters 511-1 to 511-m for each subscriber unit, optical receivers 512-1 to 512-m for each subscriber unit, and controllers 513-1 to 513-m for each subscriber unit.

The subscriber unit operates in the first embodiment operates as follows. The 1×m optical multiplexing/demultiplexing unit 509 receives and multiplexes uplink signals, and demultiplexes a downlink signal. The optical couplers 510-1 to 510-m transmit an output of the 1×m optical multiplexing/demultiplexing unit 509 to the optical transmitters 511-1 to 511-m for each subscriber unit and the optical receivers 512-1 to 512-m for each subscriber unit.

The optical transmitters 511-1 to 511-m for each subscriber unit are wavelength-locked by an incoherent light, which has been demultiplexed by the 1×m optical multiplexing/demultiplexing unit 509, and transmit uplink data.

The optical receivers 512-1 to 512-m for each subscriber unit detect a downlink optical signal demultiplexed by the 1×m optical multiplexing/demultiplexing unit 509. The controller 513-1 to 513-m for each subscriber unit control the operations of the optical transmitters 511-1 to 511-m for each subscriber unit and optical receivers 512-1 to 512-m for each subscriber unit according to time.

Hereinafter, the case for transmitting/receiving a downlink/uplink signal according to the present invention will described with second embodiment of the present invention.

According to the construction as describe above, in the case of transmitting a downlink signal, when an incoherent optical signal is output from the broadband light source 506, the optical switch 507 performs the switching operation to establish a route to the 1×n optical multiplexing/demultiplexing unit 505 by the control of the controller 504. Incoherent optical signals separated by the 1×n optical multiplexing/demultiplexing unit 505 are transmitted to the optical transmitters 501-1 to 501-n and optical receivers 502-1 to 502-n of the central office through the optical couplers 503-1 to 503-n. In this case, only the optical transmitters 501-1 to 501-n operate, but the optical receivers 502-1 to 502-n do not operate, by the control of the controller 504. Therefore, the incoherent optical signals are wavelength-locked in the optical transmitters 501-1 to 501-n of the central office, and are transmitted to the 1×n optical multiplexing/demultiplexing unit 505 through the optical couplers 503-1 to 503-n. The wavelength-locked optical signals of the optical transmitters 501-1 to 501-n are multiplexed by the 1×n optical multiplexing/demultiplexing unit 505, and then are output to the subscriber units.

A downlink optical signal multiplexed by the 1×n optical multiplexing/demultiplexing unit 505 is demultiplexed by the 1×m optical multiplexing/demultiplexing unit 509. The demultiplexed downlink optical signals are input to the optical couplers 510-1 to 510-m, and are transmitted to the optical transmitters 511-1 to 511-m and the optical receivers 512-1 to 512-m for each subscriber unit through the optical couplers 510-1 to 510-m. In this case, only the optical receivers 512-1 to 512-m for each subscriber unit operate, but the optical transmitters 511-1 to 511-m do not operate, by the control of the controllers 513-1 to 513-m.

In the case of an uplink signal according to the construction as describe above, when an incoherent optical signal is output from the broadband light source 506, the optical switch 507 performs the switching operation to establish a route to the 1×m optical multiplexing/demultiplexing unit 509 by the control of the controller 504. Incoherent optical signals demultiplexed by the 1×m optical multiplexing/demultiplexing unit 509 are transmitted to the optical transmitters 511-1 to 511-m and the optical receivers 512-1 to 512-m for each subscriber unit through the optical couplers 510-1 to 510-m. In this case, only the optical transmitters 511-1 to 511-m of each subscriber unit operate, but the optical receivers 512-1 to 512-m do not operate, by the control of the controllers 513-1 to 513-m for each subscriber unit. Therefore, the incoherent optical signals are wavelength-locked in the optical transmitters 511-1 to 511-m for each subscriber unit, and are transmitted to the 1×m optical multiplexing/demultiplexing unit 509 through the optical couplers 510-1 to 510-m. The wavelength-locked optical signals of the optical transmitters 511-1 to 511-m are multiplexed by the 1×m optical multiplexing/demultiplexing unit 509, and then are output to the central office.

An uplink optical signal multiplexed by the 1×m optical multiplexing/demultiplexing unit 509 is demultiplexed by the 1×n optical multiplexing/demultiplexing unit 505. The demultiplexed uplink optical signals are input to the optical couplers 503-1 to 503-n, and are transmitted to the optical transmitters 501-1 to 501-n and the optical receivers 502-1 to 502-n of the central office through the optical couplers 503-1 to 503-n. In this case, only the optical receivers 502-1 to 502-m of the central office operate, but the optical transmitters 501-1 to 501-m of the central office do not operate, by the control of the controller 504. Both the controller 504 of the central office and the controllers 513-1 to 513-m for each subscriber unit control the switching operations according to time.

As described above, since the switch performs the switching operation to establish a route for an uplink or a downlink according to time, uplink data or downlink data are transmitted according to time.

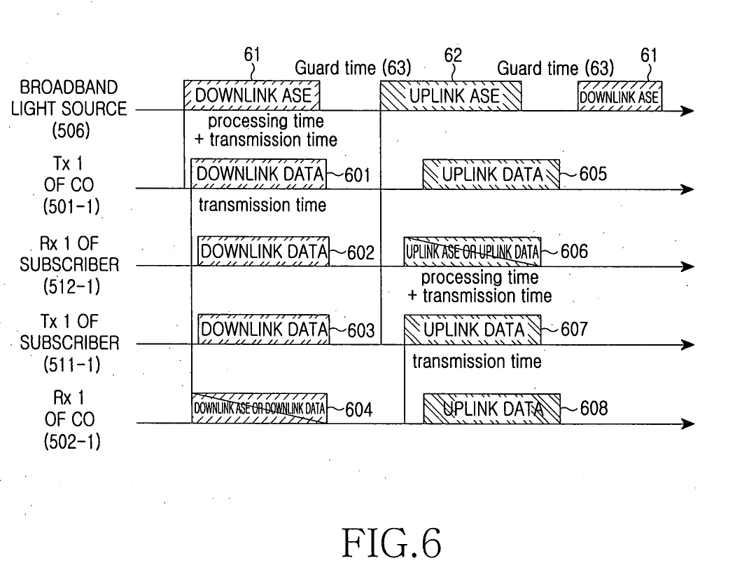

FIG. 6 is a view illustrating a result of detection for each position of uplink and downlink data in the system having the construction shown in FIG. 5.

As illustrated in FIG. 6, when the broadband light source 506 outputs a downlink incoherent optical signal (downlink ASE) 61 through the optical switch, the optical transmitters 501-1 to 501-n and optical receivers 502-1 to 502-n of the central office all detect the downlink ASE. In this case, the controller 504 controls that only the optical transmitters 501-1 to 501-n operate and can be wavelength-locked using the input downlink ASE. A downlink data 601 created in such a manner is transmitted to the subscriber units through an optical fiber. Then, the downlink data 601 is transmitted to all the optical transmitters 511-1 to 511-m and optical receivers 512-1 to 512-m of the subscriber units, and is detected therein. In this case, it is unnecessary to control downlink data 603 detected in the optical transmitters 511-1 to 511-m, because the downlink data 603 does not have any effect on the system. However, since downlink ASE or downlink data 640 detected in the optical receivers 502-1 to 502-n of the central office may cause a problem, the downlink ASE or downlink data 640 must not be detected under the control of the controller 504.

An operation similar to that described above is performed in the case of an uplink incoherent optical signal (See reference numerals 62, 605, 606, 607, and 608).

That is, the controllers 504 and 513-1 to 513-m perform control operations so that the signal detection by the optical receivers 502-1 to 502-n and 512-1 to 512-m may be prevented.

In order to prevent collisions between uplink and downlink signals, a guard time 63 is established upon the transmission of each broadband light source. Therefore, when a signal is transmitted to either the optical receivers or the optical transmitters for each unit, a difference in processing time and transmission time is caused according to its processing operation.

According to the present invention as described above, since injection lights having the same wavelength are allocated for the uplink and downlink, the efficiency of the WDM-PON is improved while reducing the type of required incoherent lights into one. Also, since the same optical transmitters and receivers to be used for the uplink and downnlink, the fabrication cost of the optical transmitter and receiver is reduced.

In addition, since an uplink signal transmission range and a downlink signal transmission range are separated from each other based on the TDD scheme, the range for the transmission of the uplink signal less than the downlink signal can be adaptively re-constructed, thereby improving the efficiency of the WDM-PON.

While the present invention has been shown and described with reference to certain preferred embodiments thereof, it will be understood by those skilled in the art that various changes in form and details may be made therein without departing from the spirit and scope of the invention as defined by the appended claims. Accordingly, the scope of the invention is not to be limited by the above embodiments but by the claims and the equivalents thereof.

What is claimed is:

1. A wavelength-division-multiplexed passive optical network (WDM-PON) system using a light source wavelength-locked by an injected incoherent light, the WDM-PON system, comprising:
an injection light generating section, which includes a broadband light source emitting an incoherent optical signal;
a central office for receiving the incoherent optical signal generated by the injection light generating section; and
the subscriber unit for receiving the incoherent optical signal generated by the injection light generating section, transmitting an uplink light by wavelength-locking the received incoherent optical signal, receiving a downlink optical signal from a central office, and detecting a light from the received downlink optical signal,
wherein the uplink and downlink optical signals transmitted between the injection light generating section, the central office, and the subscriber unit are controlled according to time.

2. The WDM-PON system as claimed in claim 1, wherein the injection light generating section provide a route for an uplink signal and a route for a downlink signal according to time.

3. The WDM-PON system as claimed in claim 1, wherein the central office:
transmits a downlink light by wavelength-locking the received incoherent optical signal;
receives an uplink optical signal from a subscriber unit; and
detects a light from the received uplink optical signal.

4. The WDM-PON system as claimed in claim 1, wherein the subscriber:
transmits an uplink light by wavelength-locking the received incoherent optical signal;
receives a downlink optical signal from a central office; and
detecting a light from the received downlink optical signal.

5. The WDM-PON system as claimed in claim 1, wherein the injection light generating section comprises:
a broadband light source for emitting the incoherent optical signal;
an optical switch for switching the incoherent optical signal, which has been output from the broadband light source, either to the central office or to the subscriber unit, by a control according to time; and
an optical router for establishing an optical route among the optical switch, the central office and the subscriber unit.

6. The WDM-PON system as claimed in claim 1, wherein the central office comprises:
a 1×n optical multiplexing/demultiplexing unit for receiving an uplink optical signal from the subscriber unit and the incoherent optical signal from the injection light generating section, demultiplexing the received optical signals, and multiplexing a downlink signal for the subscriber unit;
a plurality of switches for establishing a route between the 1×n optical multiplexing/demultiplexing unit and an optical transmitter of the central office, and a route between the 1×n optical multiplexing/demultiplexing unit and an optical receiver of the central office, by a control according to time;
the optical transmitter of the central office for transmitting the downlink optical signal, being wavelength-locked by the incoherent optical signal demultiplexed by the 1×n optical multiplexing/demultiplexing unit;
the optical receiver of the central office for detecting the uplink optical signal demultiplexed by the 1×n optical multiplexing/demultiplexing unit; and
a controller for controlling the switches according to time.

7. The WDM-PON system as claimed in claim 1, wherein the subscriber unit comprises:
a 1×m optical multiplexing/demultiplexing unit for multiplexing an uplink signal for the central office, receiving a downlink optical signal from the central office and the incoherent optical signal from the injection light generating section, and demultiplexing the received optical signals;
a plurality of switches for establishing a route between the 1×m optical multiplexing/demultiplexing unit and an optical transmitter of the subscriber unit, and a route between the 1×m optical multiplexing/demultiplexing unit and an optical receiver of the subscriber unit, by a control according to time;
the optical transmitter of each subscriber unit for transmitting the uplink optical signal, being wavelength-locked by the incoherent optical signal demultiplexed by the 1×m optical multiplexing/demultiplexing unit;
the optical receiver of each subscriber unit for detecting the downlink optical signal demultiplexed by the 1×m optical multiplexing/demultiplexing unit; and
a controller for controlling the switches according to time.

8. The WDM-PON system as claimed in claim 1, wherein the central office comprises:
a 1×n optical multiplexing/demultiplexing unit for receiving an uplink optical signal from the subscriber unit and the incoherent optical signal from the injection light generating section, demultiplexing the received optical signals, and multiplexing a downlink signal for the subscriber unit;
a plurality of optical couplers for connecting the 1×n optical multiplexing/demultiplexing unit to both an optical transmitter of the central office and an optical receiver of the central office;
the optical transmitter of the central office for transmitting the downlink optical signal, being wavelength-locked by the incoherent optical signal demultiplexed by the 1×n optical multiplexing/demultiplexing unit;
the optical receiver of the central office for detecting the uplink optical signal demultiplexed by the 1×n optical multiplexing/demultiplexing unit; and
a controller for controlling the optical transmitter of the central office and the optical receiver of the central office, according to time.

9. The WDM-PON system as claimed in claim 8, wherein the controller controls the optical receiver of the central office such that the optical receiver of the central office is prevented from operating when an operation of generating a downlink optical signal is performed.

10. The WDM-PON system as claimed in claim 8, wherein the controller controls the optical receiver of the central office such that the optical receiver of the central office is prevented from operating when an operation of generating a downlink optical signal is performed.

11. The WDM-PON system as claimed in claim 1, wherein the subscriber unit comprises:
a 1×m optical multiplexing/demultiplexing unit for multiplexing an uplink signal for the central office, receiving a downlink optical signal from the central office and the incoherent optical signal from the injection light generating section, and demultiplexing the received optical signals;
a plurality of optical couplers for connecting the 1×m optical multiplexing/demultiplexing unit to both an optical transmitter of the subscriber unit and an optical receiver of the subscriber unit;
the optical transmitter of each subscriber unit for transmitting the uplink optical signal, being wavelength-locked by the incoherent optical signal demultiplexed by the 1×m optical multiplexing/demultiplexing unit;
the optical receiver of each subscriber unit for detecting the downlink optical signal demultiplexed by the 1×m optical multiplexing/demultiplexing unit; and
a controller for controlling the optical transmitter of the subscriber unit and the optical receiver of the subscriber unit, according to time.

12. The WDM-PON system in claim 11, wherein the controller controls the optical receiver of the subscriber unit such that the optical receiver of the subscriber unit is prevented from operating when an operation of generating an uplink optical signal is performed.

13. The WDM-PON system in claim 7, wherein, in order to control, according to time, uplink and downlink optical signals transmitted among the injection light generating section, the central office, and the subscriber unit, upon transmission of the uplink optical signal, the injection light generating section transmits the incoherent optical signal to the subscriber unit;
the subscriber unit establishes a route so as to activate a system for optical transmission; and
the central office establishes a route so as to activate a system for optical reception.

14. The WDM-PON system in claim 8, wherein, in order to control, according to time, uplink and downlink optical signals transmitted among the injection light generating section, the central office, and the subscriber unit, upon transmission of the downlink optical signal, the injection light generating section transmits the incoherent optical signal to the central office;
the subscriber unit establishes a route so as to activate a system for optical reception; and
the central office establishes a route so as to activate a system for optical transmission.

15. The WDM-PON system as claimed in claim 1, wherein a guard time is established upon the transmission of each broadband light source in order to prevent collisions between uplink and downlink signals.

16. A method of providing a wavelength-division-multiplexed passive optical network (WDM-PON) system using a light source wavelength-locked by an injected incoherent light, said method comprising:
providing an injection light generating section, which includes a broadband light source emitting an incoherent optical signal; and
providing a central office for receiving the incoherent optical signal generated by the injection light generating section,
wherein the subscriber unit for receiving the incoherent optical signal generated by the injection light generating section,
wherein the uplink and downlink optical signals transmitted between the injection light generating section, the central office, and the subscriber unit are controlled according to time.

17. The method step of claim 15, further providing step of providing an injection light generating section;
wherein a route for an uplink signal and a route for a downlink signal are provided according to time.

18. The method step of claim 15, further providing step of providing a central office for receiving the incoherent optical signal generated by the injection light generating section, wherein said incoherent optical light comprises the steps of:
transmitting a downlink light by wavelength-locking the received incoherent optical signal;
receiving an uplink optical signal from a subscriber unit; and
detecting a light from the received uplink optical signal.

19. The method step of claim 15, further providing the step of providing the subscriber unit for receiving the incoherent optical signal generated by the injection light generating section, wherein said incoherent optical light comprises the steps of:
transmitting an uplink light by wavelength-locking the received incoherent optical signal;
receiving a downlink optical signal from a central office; and
detecting a light from the received downlink optical signal.

20. The method step of claim 15, further providing the step of providing a guard time established upon the transmission of each broadband light source in order to prevent collisions between uplink and downlink signals.
